(19) United States
(12) Patent Application Publication
(10) Pub. No.: US 2013/0119769 A1
(43) Pub. Date: May 16, 2013

(54) Energy Systems And Energy Storage System Charging Methods

(71) Applicants: Shane Johnson, Rosalia, WA (US); Allan Coxon, Ford, WA (US); Ian Walker, Spokane, WA (US); Scott Hamilton, Spokane, WA (US)

(72) Inventors: Shane Johnson, Rosalia, WA (US); Allan Coxon, Ford, WA (US); Ian Walker, Spokane, WA (US); Scott Hamilton, Spokane, WA (US)

(21) Appl. No.: 13/464,824

(22) Filed: May 4, 2012

Related U.S. Application Data
(63) Continuation-in-part of application No. 13/330,548, filed on Dec. 19, 2011.
(60) Provisional application No. 61/483,060, filed on May 6, 2011.

(51) Int. Cl. H02J 3/38

(52) U.S. Cl. CPC H02J 3/38
USPC 307/68

(57) ABSTRACT

Energy systems and energy storage system charging methods are described. In one aspect, an energy storage system charging method includes applying an excitation signal to a stator of an induction machine, outputting electrical energy from the stator of the induction machine during the applying, and charging an energy storage system using the electrical energy outputted from the stator.

This application is a continuation-in-part of and claims priority to a U.S. Provisional Patent Application titled “Battery Charging Devices, Battery Charging Systems, and Battery Charging Methods” filed May 6, 2011 having Ser. No. 61/483,060, and U.S. patent application titled “Energy Systems, Energy Devices, Energy Utilization Methods, and Energy Transfer Methods” filed Dec. 19, 2011 having Ser. No. 13/330,548, the teachings of which are incorporated herein by reference.

### TECHNICAL FIELD

The present disclosure relates to energy systems and energy storage system charging methods.

### BACKGROUND

Increasing availability of green energy has prompted the use of large banks of batteries to store green energy at times when the green energy is available (e.g., when the wind is blowing or the sun is shining), but might not be needed (e.g., in the middle of the night). Furthermore, there is also a need to store energy generated by traditional means during times when there is a surplus of such energy so that the stored energy may be used during times of peak demand. Traditional battery charging solutions are not designed for such applications.

### BRIEF DESCRIPTION OF THE DRAWINGS

Embodiments of the disclosure are described below with reference to the following accompanying drawings.

FIG. 1 is a block diagram of an energy system according to one embodiment.

FIG. 2 is an illustrative diagram of a network of energy devices according to one embodiment.

FIG. 3 is a block diagram of an energy device according to one embodiment.

FIG. 3A is a block diagram of an energy device according to one embodiment.

FIG. 3B is a block diagram of an energy device according to one embodiment.

FIG. 3C is a block diagram of an energy device according to one embodiment.

FIG. 4 is a schematic diagram of an energy system according to one embodiment.

FIG. 4A is a functional block diagram of control circuitry according to one embodiment.

FIG. 5 is a schematic diagram of another energy system according to one embodiment.

FIG. 5A is a functional block diagram of alternative circuitry between the power grid and power converter of FIG. 2 according to one embodiment.

FIG. 6 is a graphical representation of a charging profile of an energy storage system according to one embodiment.

FIG. 7 is a graphical representation of another charging profile of an energy storage system according to one embodiment.

### DESCRIPTION

This disclosure is submitted in furtherance of the constitutional purposes of the U.S. Patent Laws “to promote the progress of science and useful arts” (Article 1, Section 8).

According to some aspects of the disclosure, an energy system may provide power to a power grid while the power grid is operational. In one embodiment, the energy system may include an induction generator having a shaft and a stator. The induction generator may be connected to the power grid so that the power grid supplies an excitation voltage and inductive current for the induction generator. In one embodiment, the energy system may also include a motor. The motor may use energy stored by an energy storage device to rotate a rotor coupled to the shaft of the induction generator at a rotational speed greater than a synchronous speed of the induction generator in one embodiment. Consequently, the induction generator may generate AC power that is transferred to the power grid via induced magnetic coupling between the rotor and the stator.

In some embodiments, the energy system may replenish the energy stored in the energy storage device. In some embodiments, the energy system may store energy in the energy storage device and later use the stored energy to generate AC power and transfer the generated AC power to the power grid.

In some embodiments, the energy system may draw power from the power grid during times when the power is available at a first price and convert the power into energy stored by the energy storage device. Later, the energy system may convert the stored energy into AC power and provide the AC power to the power grid during times when the power may be sold to an entity operating the power grid at a second price that is higher than the first price. Additional aspects of the disclosure are described in the illustrative embodiments below.

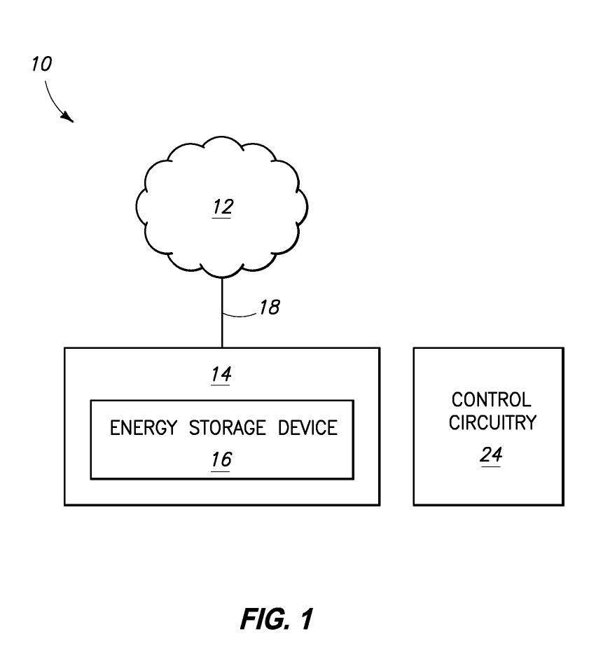

Referring to FIG. 1, an energy system 10 according to one embodiment is illustrated. System 10 includes a power grid 12, an energy device 14, and control circuitry 24. Other embodiments of system 10 are possible including more, less, and/or alternative components. In one embodiment, energy device 14 includes energy storage device 16.

Power grid 12 may provide alternating current power to a geographical area via a plurality of electrical generating facilities, transmission lines, and other infrastructure. In some embodiments, power grid 12 may be operated by an electric utility company. The power provided by power grid 12 may have a particular frequency (e.g., 60 Hz). The particular frequency may change over time in some embodiments.

Energy device 14 may operate in one of a plurality of different modes. In an energy storage mode, energy device 14 may draw power from power grid 12 via connection 18 (or in some embodiments draw the power from a power source other than power grid 12) and convert the power into energy suitable for storage in energy storage device 16. In an energy release mode, energy device 14 may convert some or all of the energy stored in energy storage device 16 into power suitable to be transferred to power grid 12 and then transfer the converted power to power grid 12 via connection 18.

Storing energy in energy device 14 and later using the energy to generate power suitable to be transferred to power grid 12 may be economically attractive because in some cases the power transferred to power grid 12 by energy device 14 while in the energy release mode may be more valuable to the utility company operating power grid 12 than the power that energy device 14 draws from power grid 12 while in the energy storage mode.

An AC power grid (such as power grid 12) may provide varying amounts of power to consumers during a twenty-four hour period in one embodiment. The amount of power provided may be greatest during a first portion of the twenty-four hour period. This first portion may be during typical working hours when usage of building lighting, HVAC systems, computers, manufacturing equipment, and the like is greatest. In contrast, power consumption during a second portion of the twenty-four hour period may be significantly lower than the consumption during the first portion. The second portion may be during night hours when most people are sleeping.

Typically, power grids have power generating capacity that meets the needs of the first portion of the twenty-four hour period. However, having such power generating capacity may be inefficient since much of the capacity may go unused during the second portion of the twenty-four hour period. Consequently, some power grid operators offer two different rates for electricity in an attempt to shift power consumption from the first portion of the twenty-four hour period to the second portion. For example, during the first portion, a first rate may be charged for electricity and during the second portion, a cheaper second rate may be charged for electricity. Such a rate structure may encourage consumers of electricity to shift their consumption to the second portion where possible to reduce the amount of money paid for electricity.

In one embodiment, energy device 14 may be configured in the energy storage mode at night when power is sold at the second rate and may be configured in the energy release mode during the day when power generated by energy device 14 may be sold back to the operator of power grid 12 at the more expensive first rate. Although the operator of power grid 12 may lose money in this transaction, the transaction may still be beneficial to the grid operator since energy device 14 may provide power to power grid 12 during periods of peak usage when the grid operator most needs additional power.

Without the power provided by energy device 14, the grid operator may need to start a more expensive or low-efficiency generating facility or buy power from another utility to meet peak power demand during the day. Additionally or alternatively, the grid operator may need to build additional power generating facilities (e.g., natural gas or oil-fired electrical plants) to meet peak demand. Being able to receive power from energy device 14 may be more efficient and cost effective than these traditional approaches to meeting peak power demand.

The above description has assumed that an entity other than the operator of power grid 12 may benefit from energy device 14. Alternatively, in one embodiment, the operator of power grid 12 may own and operate one or more energy devices 14 to provide additional power during periods of peak demand.

In one embodiment, control circuitry 24 may control the operation of energy device 14. For example, control circuitry 24 may configure energy device 14 in the energy release mode during a first portion of a twenty-four hour period (e.g., during the day) and in the energy storage mode during a second portion of a twenty-four hour period (e.g., at night). In one embodiment, control circuitry 24 may determine when demand for power is nearing the capacity of power grid 12 and in response configure energy device 14 in the energy release mode to provide additional power to power grid 12.

Control circuitry 24 may comprise circuitry configured to implement desired programming provided by appropriate media in at least one embodiment. For example, control circuitry 24 may be implemented as one or more of a processor and/or other structure configured to execute executable instructions including, for example, software and/or firmware instructions, and/or hardware circuitry. Example embodiments of control circuitry 24 include hardware logic, PGA, FPGA, ASIC, state machines, and/or other structures alone or in combination with a processor. These examples of control circuitry 24 are for illustration; other configurations are possible.

In one embodiment, control circuitry 24 may be part of energy device 14. Alternatively, control circuitry may be located remotely from energy device 14 as shown as reference 24a. In one embodiment, one portion of control circuitry 24 may be part of energy device 14 and another portion of control circuitry 24 may be remotely located from energy device 14 as shown as reference 24a.

In one embodiment, connection 18 may be a single-phase connection whereby energy device 14 may transfer and/or receive single-phase AC power to/from power grid 12. In another embodiment, connection 18 may be a multi-phase connection (e.g., three-phase connection) whereby energy device 14 may transfer and/or receive multi-phase AC power to/from power grid 12.

Energy device 14 may convert some or all of the energy stored by energy storage device 16 into a format suitable to be transferred to power grid 12. For example, in one embodiment, energy storage device 16 may include a plurality of batteries configured to supply direct current (DC) power and energy device 14 may convert some or all of the DC power from the batteries into single-phase AC power or multi-phase AC power and provide the AC power to power grid 12 via connection 18.

Furthermore, energy device 14 may increase the amount of energy stored by energy storage device 16 by converting energy into a format suitable for energy storage device 16 and then providing the converted energy to energy storage device 16 for storage. For example, in one embodiment, energy storage device 16 may include a plurality of batteries and energy device 14 may provide current to energy storage device 16 to charge the plurality of batteries. Energy device 14 may, in one embodiment, consume power from power grid 12 in charging the batteries.

In some embodiments, a plurality of energy devices, such as energy device 14, may be used to provide power to power grid 12.

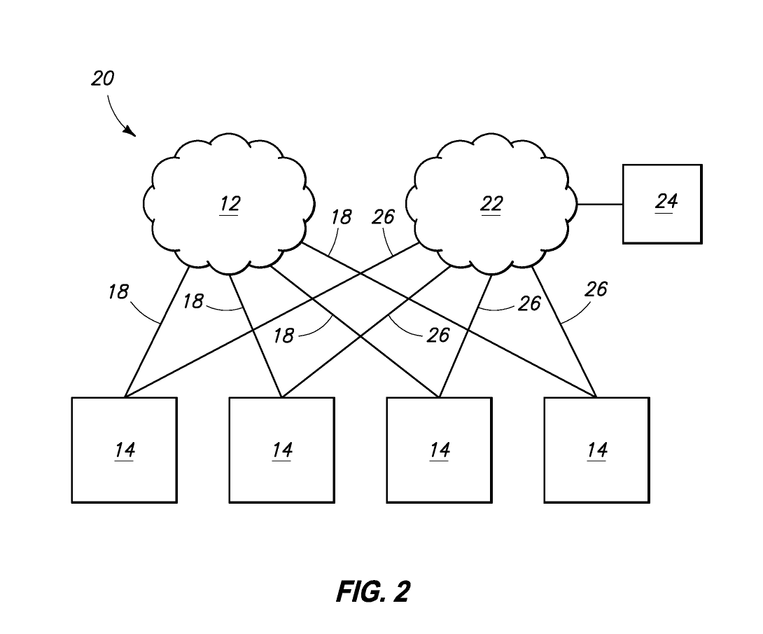

Referring to FIG. 2, a system 20 of energy devices 14, according to one embodiment, is illustrated. System 20 includes power grid 12 and a plurality of energy devices 14. Energy devices 14 are connected to power grid 12 via connections 18. Other embodiments of system 20 are possible including more, less, and/or alternative components.

System 20 also includes a communications network 22. Energy devices 14 may be connected to communications network 22 via links 26. In one embodiment, links 26 may be wired links (e.g., telephone lines, fiber optic lines, etc.) or wireless links (e.g., infrared links, radio frequency links, etc.) or a combination of wired and wireless links.

Control circuitry 24 may control energy devices 14 via communications network 22 and links 26. For example, control circuitry 24 may configure energy devices 14 in the energy release mode, the energy storage mode, or in another mode.

In one embodiment, control circuitry 24 may have access to data describing the state of power grid 12 such as data describing an electrical characteristic of power grid 12. For example, control circuitry 24 may know the frequency of AC power provided by power grid 12. Control circuitry 24 may use the data to determine when to configure one or more of energy devices 14 in the energy release mode.

For example, control circuitry 24 may determine that the frequency of power grid 12 is decreasing because demand for power from power grid 12 is increasing. In response, control circuitry 24 may configure a few of energy devices 14 in the energy release mode to supply additional power to power grid 12. If the frequency of power grid 12 increases in response, control circuitry 24 might not configure additional ones of energy devices 14 in the energy release mode. However, if the frequency of power grid 12 continues to decrease, control circuitry 24 may configure additional ones of energy devices 14 in the energy release mode.

Although only four energy devices 14 are depicted in FIG. 2, in some embodiments, network 20 may include thousands or millions of energy devices 14 connected to power grid 12. This large number of energy devices may be able to provide a substantial amount of power to power grid 12. For example, in some embodiments, thousands of kilowatts of power may be provided to power grid 12, which in some cases may be enough to temporarily keep power grid 12 stable for a period of time if one or more of the power generating facilities (e.g., power plants) of power grid 12 fails.

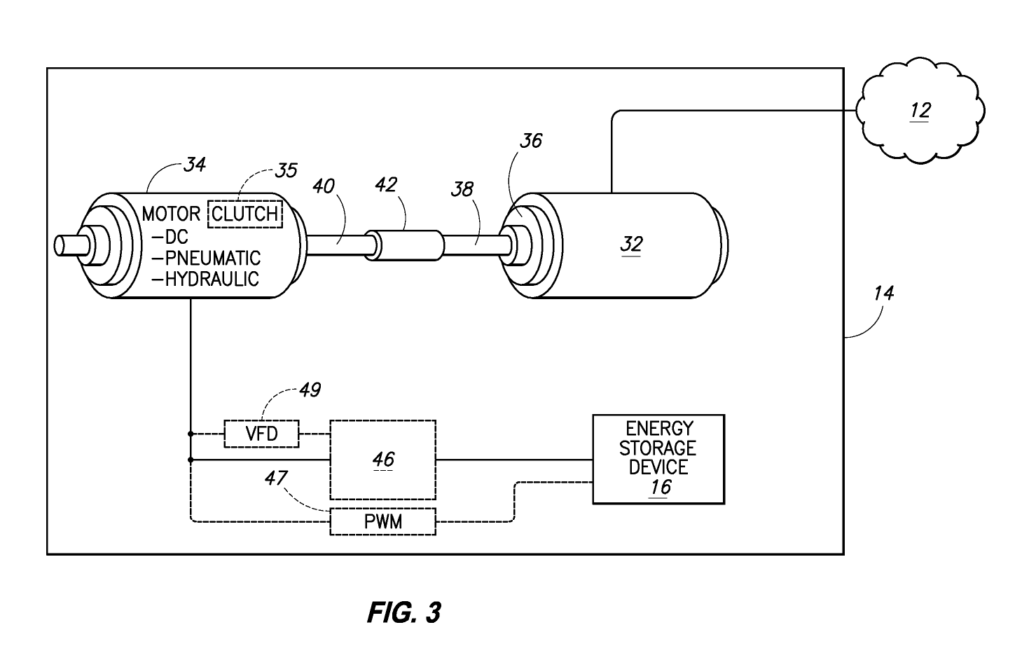

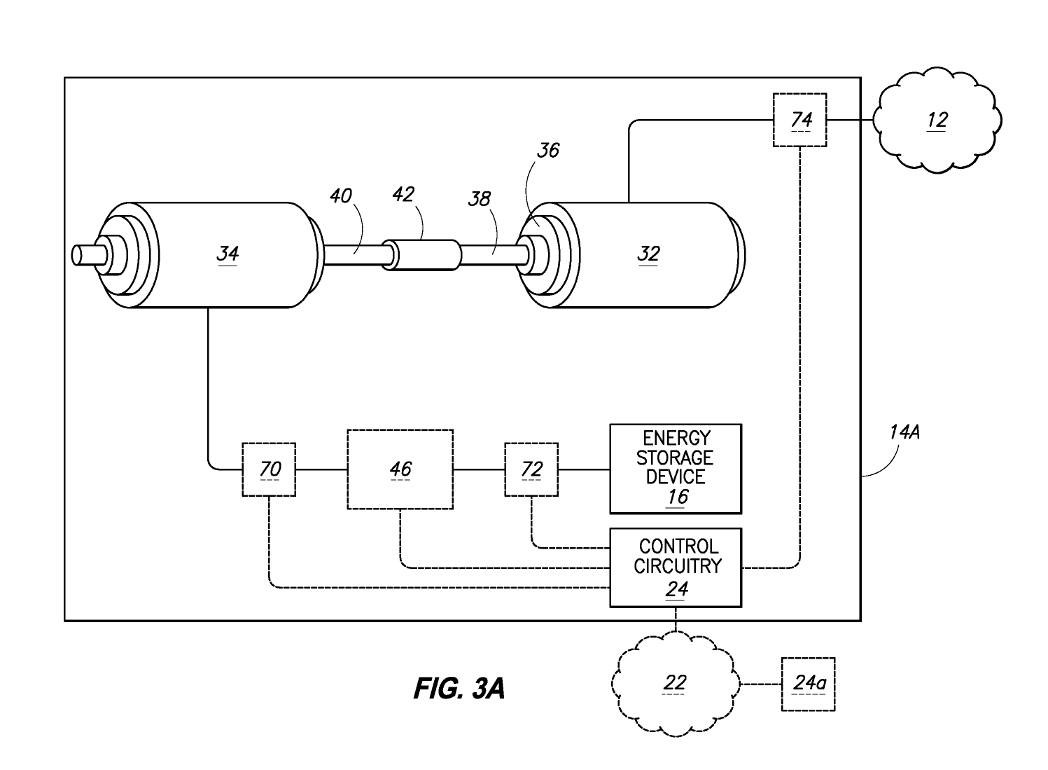

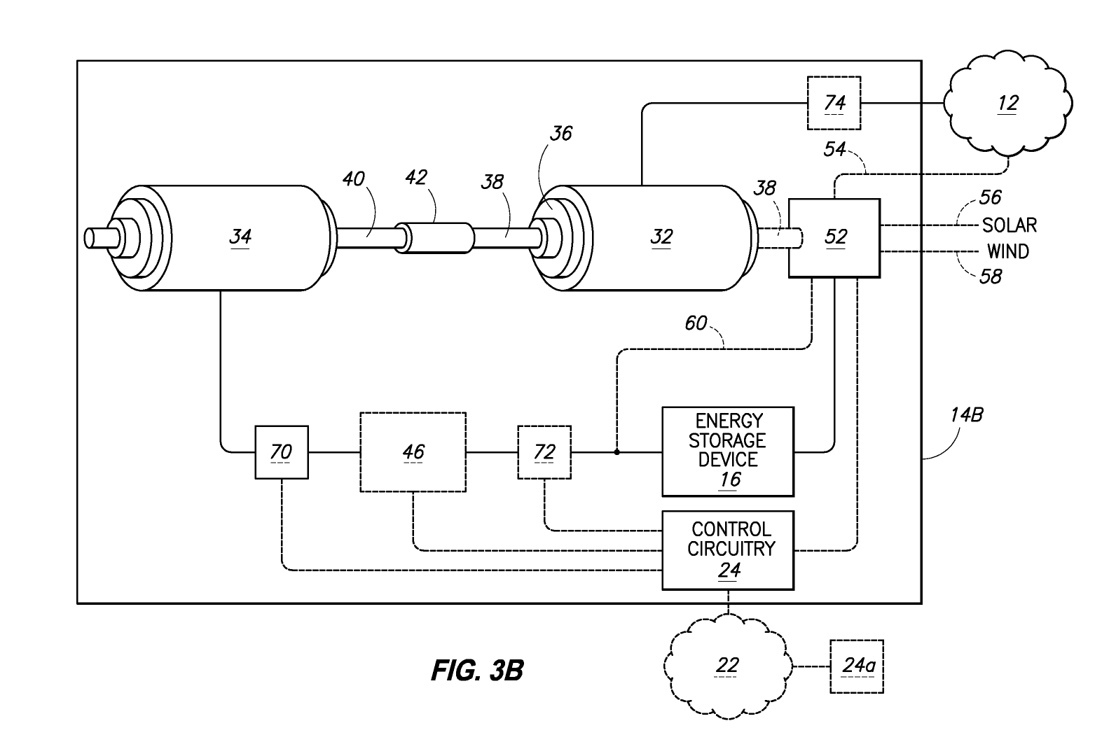

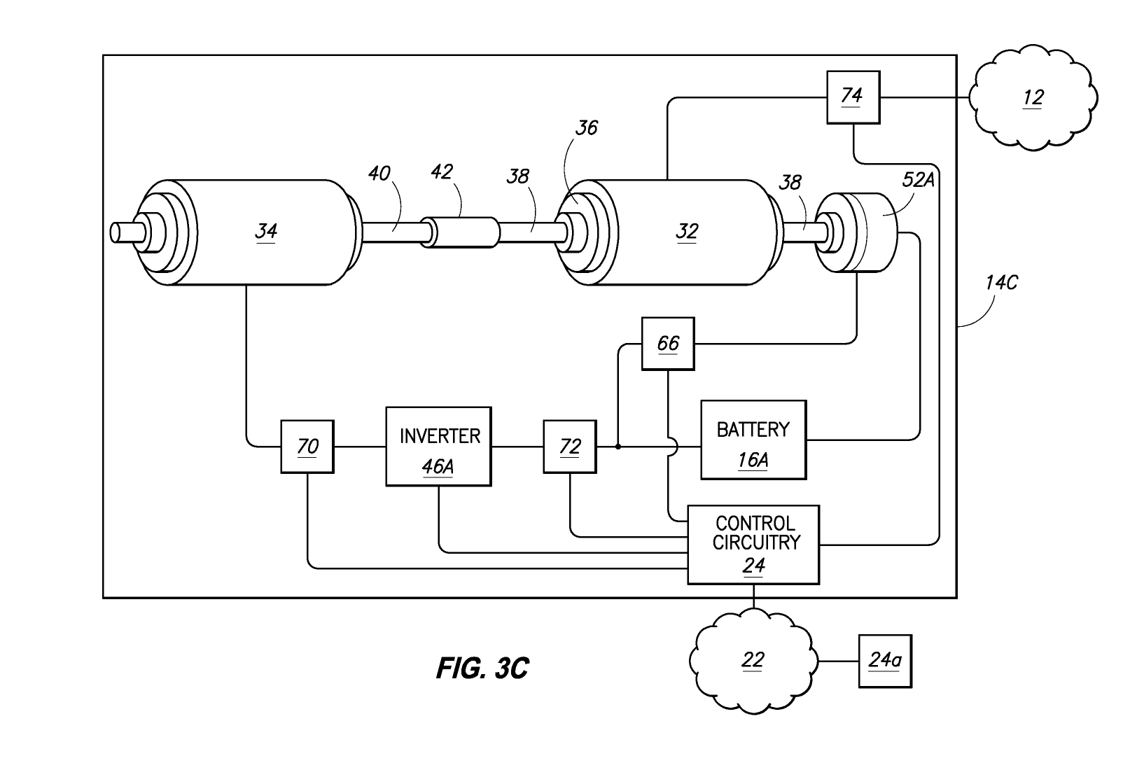

Referring to FIG. 3, an energy device 14 according to one embodiment is illustrated. Energy device 14 includes a motor 34 having a shaft 40, a generator 32 having a shaft 38 and a stator 36, and energy storage device 16. In some embodiments, energy device 14 also includes energy adapter 46. Other embodiments are also possible including more, less, and/or alternative components.

Shaft 40 may be coupled to shaft 38 via coupling 42 so that when shaft 40 is rotated, shaft 38 also rotates and conversely when shaft 38 is rotated, shaft 40 is also rotated. In one embodiment, coupling 42 may be a flexible coupling. In one embodiment, shafts 38, 40 may be referred to as first and second shafts, respectively.

Motor 34 may use energy from energy storage device 16 to rotate shaft 40. In one embodiment, motor 34 may use energy directly from energy storage device 16. For example, motor 34 may be a DC motor and energy storage device may be a battery. Alternatively, energy device 14 may include energy adapter 46, which may convert energy from energy storage device 16 into a form usable by motor 34. For example, motor 34 may be an AC motor, energy storage device 16 may include a battery, and energy adapter 46 may be an inverter configured to convert DC current from the battery into AC power usable by motor 34.

Other embodiments of motor 34 and energy storage device 16 are also possible. In one embodiment, motor 34 may be a pneumatic motor and energy storage device 16 may store compressed air or a compressed gas. In another embodiment, motor 34 may be a hydraulic motor and energy storage device 16 may store a pressurized or unpressurized liquid. In yet another embodiment, motor 34 may be a DC electric motor, energy storage device 16 may store hydrogen, and energy adapter 46 may be a fuel cell that produces DC current using the stored hydrogen. Other embodiments of motor 34 are also possible.

Motor 34 may rotate shaft 40. Since shaft 40 may be coupled to shaft 38 via coupling 42, motor 34 may rotate shaft 38 in addition to rotating shaft 40.

Generator 32 may be an induction generator and may be a single-phase induction generator or a multi-phase (e.g., three-phase) induction generator. Accordingly, generator 32 may include shaft 38, a rotor (not illustrated) coupled to shaft 38 and a stator 36. Stator 36 may be adjacent to shaft 38 and, in one embodiment, may at least partially surround shaft 38 and the rotor. When an alternating current excitation voltage is applied to stator 36, stator 36 may induce currents in the rotor. The currents may cause magnetic fields in the rotor that interact with magnetic fields present in stator 36 to rotate shaft 38. In some embodiments, current is not directly supplied to the rotor. Instead, the excitation voltage applied to the stator induces current in the rotor. In one embodiment, the generator may be referred to as asynchronous.

Stator 36 may be electrically connected to power grid 12 so that power grid 12 supplies an excitation voltage to stator 36. The excitation voltage may be an AC voltage.

In one embodiment, the motor and generator may share a single shaft. The motor may rotate the shaft when supplied with energy, for example by rotating a first rotor attached to the single shaft and associated with the motor. The generator may generate power when a second rotor (associated with the generator) attached to the single shaft and located adjacent to the stator of the generator is rotated by the motor and may transfer the generated power to the power grid. In one embodiment, the motor, the generator, and the single shaft may be within a single housing.

Generator 32 may have an associated synchronous speed related to the frequency of the excitation voltage provided by power grid 12 and the number of poles in stator 36. In one embodiment, stator 36 has two poles and the synchronous speed in revolutions per minute is the frequency of the excitation voltage multiplied by sixty. For example, if the frequency of the excitation voltage is 60 Hz, the synchronous speed is 3600 rpm. In some embodiments, the frequency of the excitation voltage supplied by power grid 12 may change over time. Accordingly, the synchronous speed of generator 32 may correspondingly change over time as the frequency of the excitation voltage changes.

In one configuration, energy from energy storage device 16 may be prevented from reaching motor 34, for example, because a switch or valve is turned off. In this configuration, motor 34 does not rotate shaft 40. However, in this configuration, power grid 12 may supply an excitation voltage to stator 36 and generator 32 may operate as a motor that turns shaft 38. Since shaft 38 is coupled to shaft 40, generator 32 may rotate shaft 40 as well as shaft 38. Thus, shaft 40 may rotate even though motor 34 is not operational (i.e., not consuming energy from energy storage device 16).

Generator 32 may rotate shafts 38 and 40 at a rotational speed that is less than the synchronous speed of generator 32. The difference between the rotational speed and the synchronous speed may be referred to as the slip of generator 32. In this configuration, generator 32 might not provide any power to power grid 12. Instead, generator 32 may consume power provided by power grid 12.

In the energy release mode, energy from energy storage device 16 is allowed to reach motor 34 (either directly or via energy adapter 46). In this configuration, motor 34 rotates shaft 40 and therefore rotates shaft 38 as well. Motor 34 may be configured to rotate shaft 40 at a constant rotational speed. For example, motor 34 may be a DC motor and energy device 14 may include a pulse width modulator 47 configured to provide DC power to motor 34 at a constant average rate from energy storage device 16 until energy storage device 16 is no longer able to provide DC power at the constant average rate. Since motor 34 receives DC power at the constant average rate from the pulse width modulator, motor 34 may rotate shaft 40 at a constant rotational speed.

Similarly, motor 34 may be an AC motor and energy device 14 may include a variable frequency drive 49 configured to provide AC power to motor 34 at a constant average frequency from energy storage device 16 until energy storage device 16 is no longer able to provide AC power at the constant average frequency.

The constant rotational speed may be higher than the synchronous speed of generator 32. In this case, when stator 36 is electrically connected to power grid 12 and is receiving an excitation voltage from power grid 12, generator 32 may supply AC power to power grid 12 via stator 36. The amount of power supplied to power grid 12 may depend on the difference between the constant rotational speed and the synchronous speed.

The power may result from the rotor of generator 32 inducing current into stator 36, which provides the induced current to power grid 12. However, in one embodiment, the power may be generated only if power grid 12 is electrically connected to stator 36 and is supplying an AC excitation voltage to stator 36. Accordingly, if power grid 12 is electrically disconnected from stator 36, generator 32 might not generate any current or voltage in either the rotor or stator 36.

Since the amount of power supplied to power grid 12 may depend on the difference between the rotational speed of shaft 38 and the synchronous speed of generator 32, and the synchronous speed of generator 32 may change if the frequency of the excitation voltage supplied by power grid 12 changes, the amount of power supplied to power grid 12 may change if the frequency of the excitation voltage changes.

This change in power may help to stabilize power grid 12. For example, the frequency of the excitation voltage supplied by power grid 12 may decrease due to additional demand placed on power grid 12. If the frequency decreases, the synchronous speed of generator 32 will also decrease. Since the rotational speed of shaft 38 (due to motor 34) remains constant, the difference between the rotational speed of shaft 38 and the synchronous speed will increase due to the decrease in frequency of the excitation voltage. Consequently, the amount of power that generator 32 provides to power grid 12 will increase. The increase in power may help meet the increased demand causing the decrease in frequency of the grid voltage which will in turn contribute to increasing the frequency of the grid voltage toward the nominal frequency of power grid 12 (e.g., 60 Hz) thereby stabilizing power grid 12.

Conversely, the frequency of the excitation voltage supplied by power grid 12 may increase due to decreased demand (or increased supply of power) placed on power grid 12. If the frequency increases, the synchronous speed of generator 32 will also increase. Since the rotational speed of shaft 38 (due to motor 34) remains constant, the difference between the rotational speed of shaft 38 and the synchronous speed will decrease due to the increase in frequency of the excitation voltage. Consequently, the amount of power that generator 32 provides to power grid 12 will decrease. The decrease in power may contribute to decreasing the frequency of the grid voltage toward the nominal frequency of power grid 12 thereby stabilizing power grid 12.

Referring to FIG. 3A, an energy device 14A according to one embodiment is illustrated. As is illustrated in FIG. 3A, in one embodiment, energy device 14A includes the elements of energy device 14 described above. In addition, energy device 14A includes control circuitry 24 and may optionally include switches 70, 72, and 74. Other embodiments are also possible including more, less, and/or alternative components.

Switch 70 may selectively allow energy to be transferred from energy adapter 46 to motor 34. Switch 72 may selectively allow energy to be transferred from energy storage device 16 to either energy adapter 46 or to motor 34. Switch 74 may selectively electrically connect motor 32 and/or stator 36 to power grid 12. In one embodiment, switches 70, 72, and 74 may be referred to as contactors.

The portion of control circuitry 24 of energy device 14A may be in communication with another portion of control circuitry 24 via communication network 22. Control circuitry 24 may control the states of switches 70, 72, and 74 by individually opening or closing switches 70, 72, and 74. For example, when energy device 14A is in the energy release mode, control circuitry 24 may close switches 70 and 72 so that energy may flow from energy storage device 16 through energy adapter 46 to motor 34. Accordingly, by controlling switches 70 and 72, control circuitry 24 may selectively cause motor 34 to rotate shaft 40 and/or shaft 38. Furthermore, control circuitry 24 may close switch 74 so that an excitation voltage from power grid 12 may be electrically connected to stator 36. In one embodiment, control circuitry 24 may also control energy adapter 46, for example, by enabling energy adapter 46 to convert energy from energy storage device 16 or by preventing energy adapter 46 from converting energy from energy storage device 16.

In one embodiment, control circuitry 24 may configure energy device 14A in the energy release mode during a particular time (e.g., at night). In another embodiment, control circuitry 24 may detect that a frequency of power grid 12 is below a threshold and in response may configure energy device 14A in the energy release mode. In another embodiment, control circuitry 24 may detect that a frequency of power grid 12 is above a threshold and in response may configure energy device 14A so that energy device 14A is not in the energy release mode. In yet another embodiment, control circuitry 24 may configure energy device 14A in the energy release mode in response to receiving a request from an operator of energy device 14A.

Referring to FIG. 3B, an energy device 14B according to one embodiment is illustrated. As is illustrated in FIG. 3B, in one embodiment, energy device 14B includes the elements of energy device 14A described above. In addition, energy device 14B includes and energy conversion device 52. Other embodiments are also possible including more, less, and/or alternative components.

Energy conversion device 52 may convert energy into a form suitable for storage in energy storage device 16. In one embodiment, energy conversion device 52 may convert energy derived from power grid 12 into a form suitable for storage by energy storage device 16. For example, energy conversion device 52 may convert rotational energy of shaft 38 and/or shaft 40 into a form suitable for storage by energy storage device 16. In one embodiment, energy storage device 16 may include one or more batteries and energy conversion device 52 may convert the rotational energy of shaft 38 and/or shaft 40 into direct current supplied to the one or more batteries. In this example, energy storage device 16 may also include a battery charger that controls the amount of direct current supplied to the one or more batteries.

In one embodiment, energy device 14B may be configured (e.g., by control circuitry 24) in the energy storage mode. In the energy storage mode, switches 70 and/or 72 may prevent energy from energy storage device 16 from reaching motor 34. Accordingly, motor 34 might not rotate shaft 40 and may be referred to as being disabled. Switch 74 may allow stator 36 to be electrically connected to power grid 12. As a result, power grid 12 may supply stator 36 with an AC excitation voltage which may cause shaft 38 (and therefore shaft 40) to rotate. The rotational energy of shafts 38 and/or 40 may be converted to a form suitable for storage by energy storage device 16 as is described above. In the energy storage mode, energy device 14B may consume power from power grid 12.

Since, in one embodiment, generator 32 may rotate shaft 38 and thereby rotate shaft 40 during moments in time when motor 34 is disabled, generator 32 may need to overcome a rotational friction associated with shaft 40 to rotate shaft 40. In one embodiment, motor 34 may include a clutch associated with shaft 40. If the clutch is engaged, motor 34 may rotate shaft 40 but if the clutch is disengaged, motor 34 might not be coupled to shaft 40 and may be unable to rotate shaft 40. When energy device 14B is in the energy storage mode, control circuitry 24 may disengage the clutch so that the rotational friction associated with shaft 40 is less when the clutch is disengaged than when the clutch is engaged. Disengaging the clutch may allow energy device 14B to more efficiently convert energy from power grid 12 into energy stored in energy storage device 16.

In one embodiment, control circuitry 24 may prevent energy conversion device 52 from converting rotational energy of shaft 38 and/or shaft 40 into energy suitable for storage in energy storage device 16 while energy device 14B is configured in the energy release mode so that energy stored in energy storage device 16 is not used to store additional energy in energy storage device 16. For example, in one embodiment, energy conversion device 52 may be an alternator. While in the energy release mode, control circuitry 24 may prevent a field from being applied to the alternator so that the alternator does not generate DC current.

Other embodiments of energy conversion device 52 are also possible. For example, energy conversion device 52 may be a compressor configured to convert rotational energy of shafts 38 and/or 40 into a compressed gas stored in energy storage device 16. In another embodiment, energy conversion device 52 may use power supplied by power grid 12 to create hydrogen fuel, which may be stored in energy storage device 16 and later used by energy adapter 46 to create DC current consumed by motor 34.

In yet another embodiment, energy conversion device 52 may include a battery charger that may draw AC power from power grid 12, convert the AC power from power grid 12 into a DC current, and charge batteries of energy storage device 16 using the DC current. In some configurations, control circuitry 24 may be configured to enable and/or disable the battery charger.

Other embodiments of energy conversion device 52 may convert energy that is not derived from power grid 12 (e.g., naturally occurring energy) into a form suitable for storage in energy storage device 52. For example, energy conversion device 52 may convert solar power 56 and/or wind power 58 into a DC current, which may be used to charge one or more batteries of energy storage device 16.

In one embodiment, motor 34 may be a DC motor having a rotor with one or more magnets. The DC motor may be configured by control circuitry 24 to provide DC current when shafts 38 and 40 are being rotated by generator 32. Control circuitry 24 may control the amount of DC current provided by the DC motor by adjusting the amount of field current supplied to the DC motor. Accordingly, the DC motor may be used to produce a DC current that may be used to charge one or more batteries of energy storage device 16.

In one embodiment, control circuitry 24 may determine an amount of energy stored in energy storage device 16. For example, if energy storage device 16 includes a battery, control circuitry 24 may determine a voltage level of the battery. Control circuitry 24 may use the amount of energy stored to determine when to configure energy device 14B in the energy storage mode. For example, if the amount of energy stored in energy storage device 16 falls below a threshold, control circuitry 24 may configure energy device 14B in the energy storage mode. As a result, additional energy may be stored in energy storage device 16.

Control circuitry 24 may additionally or alternatively configure energy device 14B in the energy release mode based on the amount of energy stored.

In one embodiment, energy device 14B may be configured to fill energy storage device 16 in a first amount of time and to consume the energy stored in energy storage device 16 in a second amount of time. The first amount of time may be less than the second amount of time. For example, if energy storage device 16 includes a battery, energy device 14B may be configured to charge the battery in a first amount of time and to discharge the battery (by powering motor 34 in the energy release mode) in a second amount of time. In some embodiments, the first amount of time may be less than half of the second amount of time.

Referring to FIG. 3C, an energy device 14C according to one embodiment is illustrated. As is illustrated in FIG. 3C, energy device 14C includes motor 34, shaft 40, coupling 42, shaft 38, stator 36, generator 32, control circuitry 24, and switches 70, 72, and 74 described above. In the embodiment of FIG. 3C, motor 34 may be an AC induction motor. In addition, energy device 14C includes a battery 16A, an alternator 52A configured to convert rotational energy of shafts 38 and/or 40 into DC current used to charge battery 16A, a switch 66, and an inverter 46A. Other embodiments are also possible including more, less, and/or alternative components.

Inverter 46A may convert DC current supplied by battery 16A into AC power supplied to AC induction motor 34. In one embodiment, the AC power produced by inverter 46A may have a frequency higher than the frequency of the AC power supplied by power grid 12. For example, the AC power supplied by power grid 12 may have a frequency of 60 Hz and the AC power supplied by inverter 46A may have a frequency of 65 Hz.

Since motor 34 is supplied with the AC power provided by inverter 46A (which has a frequency higher than the frequency of the AC power supplied by power grid 12), motor 34 may have a higher synchronous speed than the synchronous speed of generator 32. Accordingly, motor 34 may rotate shafts 40 and 38 at a rotational speed higher than the synchronous speed of generator 32 which, as was described above, may generate power that may be provided to power grid 12 via stator 36.

Switch 66 may be used to allow or prevent a field current from being supplied to alternator 52A from battery 16A. Allowing the field current may enable alternator 52A to produce DC current from rotational energy of shafts 40 and/or 38, for example, when energy device 14C is in the energy storage mode. Preventing the field current may prevent alternator 52A from producing DC current from rotational energy of shafts 40 and/or 38, for example, when energy device 14C is in the energy release mode. Furthermore, preventing the field current may reduce a rotational friction associated with shafts 40 and/or 38 as compared to when the field current is allowed. Reducing the rotational friction may increase the efficiency with which energy device 14C may provide power to power grid 12.

Energy systems and energy storage system charging methods are disclosed. Such may be used to charge battery banks using green energy when it is available or using traditionally generated energy.

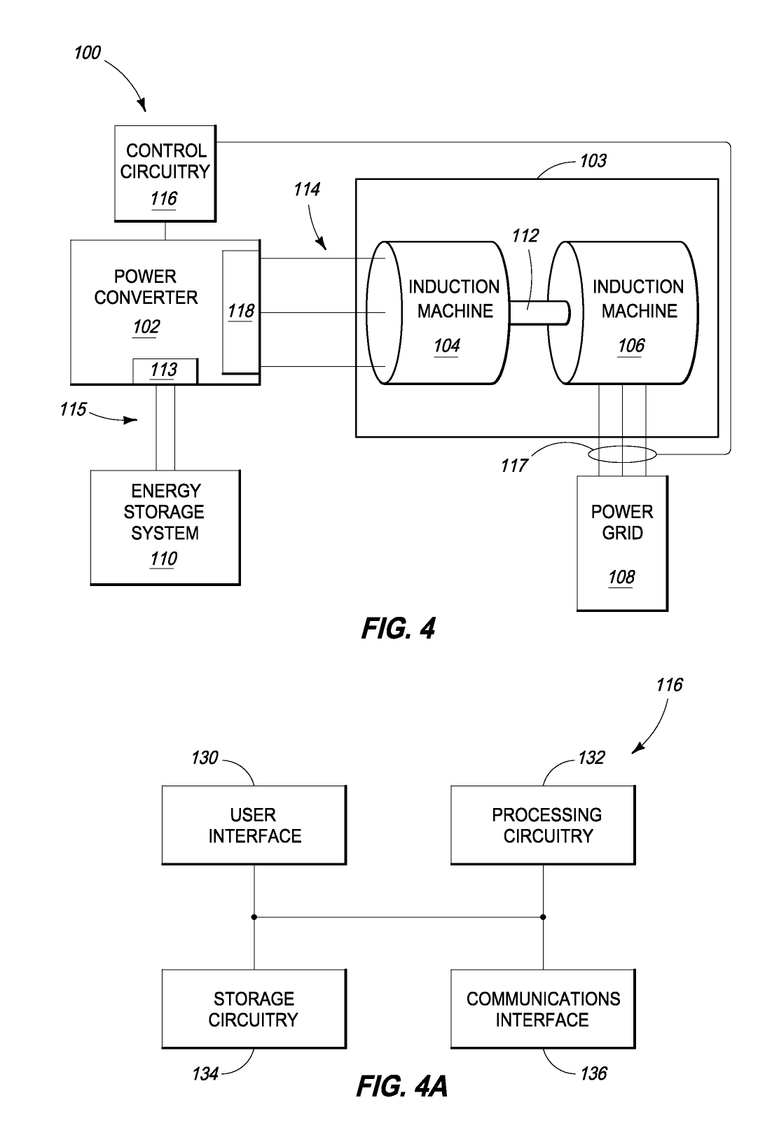

Referring to FIG. 4, one embodiment of an energy system 100 is illustrated for charging an energy storage system 110, such as a battery bank. System 100 may also be used for discharging energy stored by energy storage system 110 to a power grid 108. System 100 includes a power converter 102 and an electromechanical system 103 including one induction machine 104 coupled by a shaft 112 to another induction machine 106 in the illustrated embodiment. In other embodiments, additional induction machines may also be mechanically coupled with one or both of the illustrated induction machines 104, 106.

In some embodiments, energy system 100 (and energy system 200 discussed below) may be configured as the energy system discussed above with respect to FIGS. 1-3C. In addition, in some embodiments, one or more aspects of the energy devices and systems discussed above with respect to FIGS. 1-3C may be implemented in embodiments of the energy systems 100, 200 discussed below. Furthermore, one or more aspects of the energy systems 100, 200 discussed below may be incorporated into the embodiments of the energy devices and systems disclosed above in FIGS. 1-3C.

For example, in some embodiments, power converter 102 may include or be implemented as energy adapter 46, pulse width modulator 47, variable frequency drive 49, or energy conversion device 52; induction machines 104, 106 may include or be implemented as generator 32 and motor 34 discussed above; energy storage system 110 may include energy storage device 16 (and a battery charger in some embodiments when system 110 includes one or more rechargeable batteries); control circuitry 116 may include control circuitry 24; and vice-versa.

In one embodiment, power converter 102 operates to change format and/or characteristics of electrical energy flowing through the power converter 102. For example, power converter 102 may operate to invert and/or rectify electrical energy. In one more specific example, power converter 102 may invert electrical energy flowing in one direction and may rectify electrical energy flowing in another direction. Furthermore, power converter 102 may change a characteristic of the electrical energy, for example, boost the voltage of the electrical energy.

Power converter 102 may be configured in a number of different ways in different embodiments. In one example, power converter 102 may be a regenerative variable frequency drive such as the Emerson Unidrive SP. In other embodiments, power converter 102 is implemented as switching circuitry, for example, a plurality of transistors which are pulse width modulated to provide inverter, rectifier, boost, and/or buck operations. Furthermore, the power conversion operations of power converter 102 may be controlled to control charging of energy storage system 110 and/or operations of electromechanical system 103 as described further below. Other embodiments of power converter 102 are of course possible.

A stator of induction machine 106 is connected to power grid 108 and energy storage system 110 is connected to power converter 102. Control circuitry 116 is in communication with power converter 102 and may control power converter 102. In one embodiment, machines 104, 106 may both be AC induction machines individually capable of operating as both induction motors and induction generators as discussed above with respect to generator 32, and motor 34. As discussed further below, energy system 100 may operate in different modes at different moments in time and the AC induction machines individually operate as one of a motor and a generator during these different operational modes and the operation of the individual induction machines may change between that of a motor and a generator during the operation of the energy system 100 in the different modes.

In one example mode, electromechanical system 103 receives electrical energy from power grid 108 (or other source of electrical energy) and provides electrical energy to power converter 102. In this example, induction machine 106 may operate as a motor to use electrical energy from power grid 108 to rotate a shaft, while induction machine 104 operates as generator to output electrical energy as a result of the rotation of the shaft.

In another example mode, electromechanical system 103 receives electrical energy from power converter 102 and provides electrical energy to power grid 108. In this example, induction machine 104 may operate as a motor to use electrical energy from energy storage system 118 to rotate a shaft, while induction machine 106 operates as generator to output electrical energy to power grid 108 as a result of the rotation of the shaft. Control circuitry 116 may control operation of the electromechanical system 103 in the different operational modes as discussed in additional detail below.

In one embodiment, power converter 102 may create (e.g., synthesize) a desired signal from a DC or AC power source. To do so, power converter 102 may combine a plurality of individual signals to create a composite signal having desired characteristics (e.g., amplitude, shape, frequency, etc.). In one embodiment, the composite signal may be a periodic AC signal. Power converter 102 may control the duration and timing of a plurality of individual signals within the power converter 102 to synthesize the desired composite signal. In one embodiment, power converter 102 may pulse width modulate each of the individual signals so that the combination of the individual signals is the desired signal.

In one embodiment, power converter 102 may comprise a plurality of insulated-gate bipolar transistors (IGBTs). Each of the IGBTs may be controlled by power converter 102 to generate one of the individual signals. The outputs of the IGBTs may be summed together to provide a desired composite output signal. In controlling each of the IGBTs, power converter 102 may control when the IGBT is turned on and the duration for which the IGBT is turned on. As a result, the amplitude, frequency, shape, and other characteristics of the composite output signal may be controlled.

In synthesizing the signal, power converter 102 may consume power (e.g., AC power or DC power) supplied to power converter 102. For example, each IGBT may selectively conduct or not conduct DC power in a manner similar to a switch. In some embodiments, power converter 102 may generate a plurality of synthesized composite signals. For example, as illustrated in FIG. 4, power converter 102 generates a three-phase signal on a three-phase interface 114 connected to port 118 of power converter 102. The three-phase interface 114 is connected to a stator of machine 104.

Power converter 102 may modify characteristics of the synthesized composite signal over time such as frequency, phase, amplitude, waveform shape (e.g., square wave, sine wave, etc.), and the like. For example, power converter 102 may alter the frequency of the synthesized signal by increasing and/or decreasing the frequency over time. In one embodiment, machine 104 may be an AC induction motor and the frequency of the synthesized signal may be varied over time so that machine 104 rotates shaft 112 at different speeds or to control the amount of power outputted by the machine 104, and for example, provided to power converter 102. In one embodiment, the frequency may be varied by adjusting a parameter of power converter 102 and/or by enabling or adjusting devices external to power converter 102 such as external resistance, inductance, or capacitance.

One example embodiment of power converter 102 is a variable frequency drive. Variable frequency drives are commonly used to drive AC induction motors and to control a speed with which an induction motor rotates a shaft. The speed may be controlled by adjusting one or more parameters of the variable frequency drive. Such variable frequency drive parameters may include, for example, frequency, speed, revolutions per minute, DC bus voltage, AC voltage, phase, torque, and other parameters that may directly or indirectly affect the speed with which the induction motor rotates the shaft. The one or more parameters of the variable frequency drive may be adjusted, for example, using control circuitry 116 to communicate with the variable frequency drive to change the values of the parameters.

In some embodiments, power converter 102 may receive a desired frequency from control circuitry 116 and may control the individual signals generated by power converter 102 (e.g., by controlling which individual IGBTs are turned on at a given moment in time, when individual IGBTs are turned on, and how long the individual IGBTs are left on) so that the composite signal generated by power converter 102 has the desired frequency. As a result, since the composite signal having the desired frequency is connected to the stator of machine 104, machine 104 will strive to rotate shaft 112 at a desired rotational speed proportional to the desired frequency. In some situations, machine 104 might not be able to rotate shaft 112 at the desired rotational speed due to a load coupled to shaft 112. Despite this, machine 104 may continue to strive to rotate shaft 112 at the desired rotational speed.

The frequency of the synthesized composite signal may be referred to as the frequency set point of power converter 102. In one embodiment, control circuitry 116 may alter the frequency set point of power converter 102. For example, control circuitry 116 may communicate a desired frequency set point to power converter 102. Alternatively, control circuitry 116 may control a different parameter of power converter 102, such as a voltage, current, torque, revolutions per minute, phase, or speed parameter to indirectly change the frequency set point.

As illustrated in FIG. 4, power converter 102 may include at least two ports 118 and 113. At port 118, power converter 102 presents the synthesized composite signal. In general, port 118 may be an output port. However, in some situations, current may flow into power converter 102 via port 118. For example, as described below, in some situations the frequency of the synthesized composite signal may be adjusted so as to purposely cause current to flow into power converter 102 via port 118.

At port 113, power converter 102 may operate as a battery charger and present a DC voltage to charge rechargeable batteries of energy storage system 110. In some cases, power converter 102 may be controlled so that the DC voltage is greater than a voltage of energy storage system 110 by design. As a result, current may flow from port 113 to energy storage system 110. In some arrangements, electrical energy from power grid 108 may be used to charge the energy storage system 110 and the energy storage system 110 may, when fully charged, have a voltage greater than a peak voltage of the power grid 108. Accordingly, in some embodiments, power converter 102 is arranged as a boost converter to increase a voltage of electrical energy during rectifying operations above the voltage of the energy storage system 110 when fully charged to enable charging of the energy storage system 110 to a fully charged state of charge.

In other situations, power converter 102 may be controlled so that energy storage system 110 presents a DC voltage greater than the voltage presented at port 113. As a result, current may flow from energy storage system 110 to power converter 102. In fact, power converter 102 may consume DC power provided by energy storage system 110 via port 113 in synthesizing the desired composite signal that power converter 102 presents at port 118. Thus, by controlling power converter 102 (e.g., by controlling the frequency set point of power converter 102), current may be caused to flow from energy storage system 110 to power converter 102 at some moments in time and may be caused to flow from power converter 102 to energy storage system 110 at other moments in time.

In one mode of operation, power converter 102 may be configured with a frequency set point that is greater than a frequency of AC power provided by power grid 108. For example, in one embodiment, the frequency set point may be between 2% and 5% higher than the frequency of the AC power of power grid 108. As a result, machine 104 will strive to rotate shaft 112 at a rotational speed proportional to the frequency set point. In doing so, since machine 104 is connected to machine 106 by shaft 112, shaft 112 will rotate machine 106. Power converter 102 may consume energy stored by energy storage system 110 to provide an AC signal having a frequency equal to the frequency set point to machine 104.

In one embodiment, machine 106 may be an AC induction motor. As a result, since shaft 112 may be rotating at a rotational speed greater than the rotational speed (e.g., synchronous speed) associated with the frequency of AC power provided by power grid 108 and present at the stator of machine 106, machine 106 may generate AC power that flows to power grid 108. Further detail regarding this mode of generating AC power using a motor and an AC induction machine may be found in U.S. patent application Ser. No. 12/165,405 filed on Jun. 30, 2008 and naming Scott Hamilton as inventor, which is incorporated herein by reference.

In another mode of operation, system 100 may charge energy storage system 110. In this mode, power grid 108 is connected to a stator of machine 106 so that machine 106 consumes power from power grid 108 to turn shaft 112. Machine 106 may turn shaft 112 at a rotational speed proportional to a frequency of the AC power supplied by power grid 108. In rotating shaft 112, machine 106 may turn machine 104, which may be an AC induction motor. Due to the rotation of shaft 112, machine 104 may generate AC power that flows from the stator of machine 104 to port 118 if an excitation signal (e.g., AC signal) is present on the stator. Power converter 102 may generate such an excitation signal and present the excitation signal to the stator of machine 104. In doing so, power converter 102 may generate the excitation signal having a selected characteristic. For example, power converter 102 may generate the excitation signal having a frequency that is less than the frequency of AC power supplied by power grid 108. For example, the frequency of the excitation signal presented to the stator of machine 104 may be 58.8 Hz when the frequency of the AC power supplied by power grid 108 may be 60 Hz. In this mode, power converter 102 may act to brake machine 104.

Since the frequency of the excitation signal presented to the stator of machine 104 is less than the frequency associated with the rotational speed of shaft 112 (the frequency of the AC power supplied by power grid 108), machine 104 may generate AC power and the AC power may flow from the stator of machine 104 to port 118 of power converter 102. Power converter 102 may control the amount of electrical energy outputted from the stator of machine 104 to the interface 118 by varying a characteristic (e.g., frequency) of the excitation signal. In general, increased amounts of electrical energy flow from the stator of machine 104 to the interface 118 corresponding to increased (or greater) differences between the frequency of the excitation signal and the frequency of rotation of the machine 104. As discussed below, control circuitry 116 may monitor the energy storage system 110 (e.g., monitor the voltage or state of charge 110) and adjust a characteristic (e.g., frequency) of the excitation signal generated by power converter 102 to control the amount of electrical energy outputted from machine 104 to the power converter 102 for use in charging the energy storage system 110. As discussed further below, the control circuitry 116 may utilize a charging profile which corresponds to the chemistry of the batteries within the energy storage system 110 to control the characteristic of the excitation signal and the appropriate amount of electrical energy to be outputted from machine 104 to be used to charge the energy storage system 110.

Power converter 102 may convert the AC power to DC power (e.g., by rectifying the AC power) and present the DC power on port 113. The DC power may flow to energy storage system 110 via DC interface 115. In one embodiment, power converter 102 may be a regenerative variable frequency drive configured to convert AC power received on port 118 to DC power and make the DC power available on port 113. In one embodiment, the regenerative variable frequency drive may include diode-based rectifying circuitry. As a result of the conversion of the AC power received on port 118 to DC power, a voltage at port 113 increases as power converter 102 tries to push the converted DC power into energy storage system 110.

DC power presented on port 113 may charge energy storage system 110 if the DC power has a voltage that is greater than a voltage of energy storage system 110. In some cases, the rectified DC power might not be level. For example, the rectified signal may have an AC component to it. However, energy storage system 110 may tolerate the AC component or in some cases may even benefit from the AC component since the AC component may help to displace sulfates that have accumulated on anodes of the batteries of energy storage system 110. Other battery conditioning techniques are also possible. For example, power converter 102 may be configured to produce a desired signal that has a beneficial effect on the life of energy storage system 110, the amount of time required to charge energy storage system 110, or other characteristic of energy storage system 110.

Energy storage system 110 when configured as a battery bank may include one or many batteries. The batteries may use any suitable battery technology. For example, the batteries may use lead acid technology, nickel metal hydride technology, lithium ion technology, sodium-based technology, or other battery technology. By way of example, in some embodiments, energy storage system 110 may store up to 100 kW/400 kWH. Other embodiments are also possible in which more or less energy is stored in energy storage system 110.

As energy storage system 110 is charging using the DC power presented on port 113 of power converter 102, control circuitry 116 may monitor a voltage of energy storage system 110. As the monitored voltage increases, control circuitry 116 may increase the frequency set point of power converter 102 which operates to increase the frequency of the excitation signal. As a result, the amount of DC power presented on port 113 may decrease thereby decreasing the rate at which energy storage system 110 is charged because the difference between the frequency set point and the frequency of the AC power supplied by power grid 108 is decreased. In this manner, the charging of energy storage system 110 may be controlled in a way that optimizes the battery life of energy storage system 110. As was discussed above, the frequency set point of power converter 102 (and frequency of the excitation signal) may be increased or decreased by changing one or more parameters of power converter 102, such as, a frequency, speed, voltage, current, revolutions per minute, torque, or other parameter of power converter 102.

For example, for one battery technology, it may be advantageous to charge at a high rate when energy storage system 110 is at less than 50% of its capacity and to charge at a lower rate when energy storage system 110 is at greater than 50% of its capacity. Control circuitry 116 may monitor a number of parameters associated with energy storage system 110 or power converter 102. For example, control circuitry 116 may monitor a temperature of energy storage system 110, a voltage of energy storage system 110, an amount of time that energy storage system 110 has been charging, an amount of current flowing into port 118, a voltage at port 113, and/or other parameters. Control circuitry 116 may take action based on one or more of these parameters. For example, control circuitry 116 may begin or cease charging energy storage system 110, may change the rate at which energy storage system 110 is being charged by controlling the characteristic of the excitation signal, etc.

In some embodiments of power converter 102, control circuitry 116 controls the amount of DC power provided to energy storage system 110 by controlling a parameter of power converter 102 rather than the frequency set point. For example, some variable frequency drives (which are examples of power converters) may be controlled by setting a DC voltage parameter rather than a frequency set point. The DC voltage parameter may represent a desired voltage that power converter 102 is to impose at port 113. By increasing the DC voltage parameter, control circuitry 116 may increase the rate at which energy storage system 110 is charged. Similarly, by decreasing the DC voltage parameter, control circuitry 116 may decrease the rate at which energy storage system is charged.

Although control circuitry 116 may change the DC voltage parameter of power converter 102, the net effect to power converter 102 may be that a characteristic (e.g., frequency) of the synthesized composite excitation signal presented by power converter 102 at port 118 may be altered to provide the desired DC voltage at port 113. For example, if the desired DC voltage parameter is increased, power converter 102 may decrease the frequency of the synthesized composite excitation signal presented at port 118 so that additional AC power flows from the stator of machine 104 into port 118. This additional AC power may be rectified by power converter 102 and used to increase the DC voltage at port 113.

Similarly, if the desired DC voltage parameter is decreased, power converter 102 may increase the characteristic (e.g., frequency) of the synthesized composite excitation signal presented at port 118, thereby decreasing the amount of AC power flowing from the stator of machine 104 into port 118 because the difference between the frequency of the synthesized composite output and the frequency of the AC power provided by power grid 108 is decreased. Accordingly, changing the DC voltage parameter of power converter 102 may indirectly result in a change in the frequency of the synthesized composite output presented by power converter 102 at port 118.

Other embodiments of power converter 102 are also possible in which different parameters (e.g., current parameters, voltage parameters, etc.) may be controlled by control circuitry 116 in order to change the voltage at port 113 and thereby change a rate at which energy storage system 110 is charged by DC power supplied by port 113.

In one embodiment discussed below with respect to FIG. 4A, control circuitry 116 may include processing circuitry configured to process computer program instructions stored by control circuitry 116. The computer program instructions may be optimized for a particular battery technology so that the computer program instructions maximize battery life.

As discussed herein, control circuitry 116 may monitor and control various operations of energy system 100. For example, control circuitry 116 may monitor and/or control power converter 102 (e.g., control pulse width modulation, monitor and/or control characteristics of ports 113, 118 such as voltages, frequencies, etc., control characteristics of generated excitation signals, etc.), energy storage system 110 (e.g., monitor state of charge, rates of charging or discharging, etc.), electromechanical system 103 (e.g., control operational modes, and control and/or monitor operations to provide electrical energy to power converter 102 and/or receiving electrical energy from power converter 102), and power grid (e.g., monitoring characteristics of electrical energy upon the power grid 108, such as frequency, phase, magnitude, etc.). In one embodiment, sensor circuitry 117, such as a power meter, may be configured to monitor characteristics of one or more phases or legs of the power grid 108, such as frequency, phase, and voltage magnitude and the control circuitry 116 may obtain information regarding the monitored characteristics from sensor circuitry 117.

Referring to FIG. 4A, one embodiment of control circuitry 116 is shown. In the illustrated example embodiment, control circuitry 116 includes a user interface 130, processing circuitry 132, storage circuitry 134, and a communications interface 136. Other embodiments of control circuitry 116 are possible including more, less and/or alternative components.

User interface 130 is configured to interact with a user including conveying data to a user (e.g., displaying visual images for observation by the user) as well as receiving inputs from the user. For example, user interface 130 may convey status information and receive user commands regarding operations of system 100, such as whether energy storage system 110 is charging/discharging, operational mode of electromechanical system 103, power grid status 108, etc.

In one embodiment, processing circuitry 132 is arranged to process data, control data access and storage, issue commands, and control other desired operations. Processing circuitry 132 may comprise circuitry configured to implement desired programming provided by appropriate computer-readable storage media in at least one embodiment. For example, the processing circuitry 132 may be implemented as one or more processor(s) and/or other structure configured to execute executable instructions including, for example, software and/or firmware instructions. Other exemplary embodiments of processing circuitry 14 include hardware logic, PGA, FPGA, ASIC, state machines, and/or other structures alone or in combination with one or more processor(s). These examples of processing circuitry 132 are for illustration and other configurations are possible.

Storage circuitry 134 is configured to store programming such as executable code or instructions (e.g., software and/or firmware), electronic data, databases, image data, or other digital information and may include computer-readable storage media. At least some embodiments or aspects described herein may be implemented using programming stored within one or more computer-readable storage medium of storage circuitry 134 and configured to control appropriate processing circuitry 132. In one more specific example, storage circuitry 134 may contain information regarding the energy storage system 110, such as the types of batteries utilized and the respective charging profiles therefor, and the processing circuitry 132 may control operations of charging/discharging of the energy storage system 110 according to the stored information.

The computer-readable storage medium may be embodied in one or more articles of manufacture which can contain, store, or maintain programming, data and/or digital information for use by or in connection with an instruction execution system including processing circuitry 132 in the exemplary embodiment. For example, exemplary computer-readable storage media may be non-transitory and include any one of physical media such as electronic, magnetic, optical, electromagnetic, infrared or semiconductor media. Some more specific examples of computer-readable storage media include, but are not limited to, a portable magnetic computer diskette, such as a floppy diskette, a zip disk, a hard drive, random access memory, read only memory, flash memory, cache memory, and/or other configurations capable of storing programming, data, or other digital information.

Communications interface 136 is arranged to implement communications of control circuitry 116 with respect to external devices. For example, communications interface 116 may be arranged to communicate information bi-directionally and may output commands to power converter 102 and receive information (e.g., status) of one or more components of system 100, such as power converter 102, machine 104, machine 106, and/or energy storage system 110, and perhaps other components or entities, such as power grid 108.

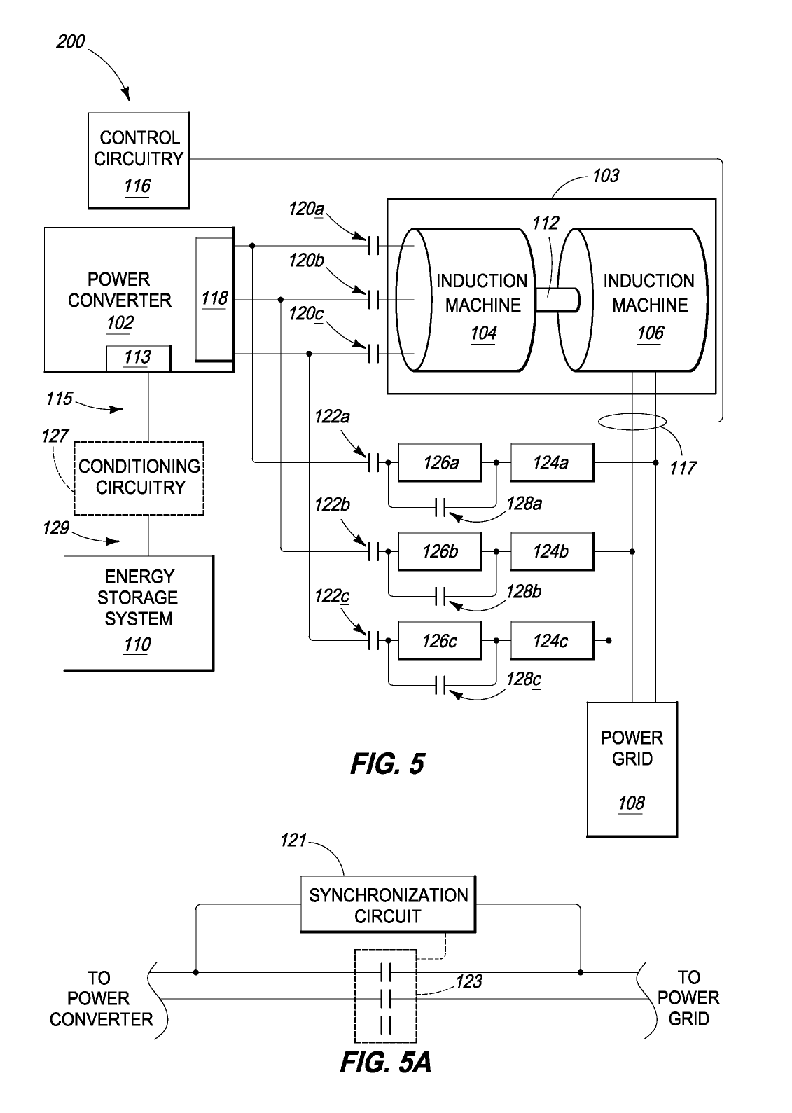

Referring now to FIG. 5, another energy system 200 for charging energy storage system 110 is illustrated. System 200 includes the components of the system 100 as well as some additional components. For example, system 200 may charge energy storage system 110 using AC power supplied directly from power grid 108 and/or using AC power supplied by the stator of machine 104 as described above.

System 200 may be used to supply energy stored by energy storage system 110 to power grid 108 using the techniques described above. When supplying energy to power grid 108, system 200 may be put into a particular configuration. In this configuration, contactors 120a, 120b, and 120c may be closed so that machine 104 is electrically connected to port 118 of power converter 102. Furthermore, in this configuration, contactors 122a, 122b, and 122c may be open, thereby preventing direct electrical connection between port 118 and power grid 108.

Different configurations may be used when system 200 is charging energy storage system 110. In one charging configuration, contactors 120a, 120b, and 120c may be open so that machine 104 is not electrically connected to port 118 of power converter 102 and contactors 122a, 122b, 122c, 128a, 128b, and 128c may be closed, electrically connecting port 118 to power grid 108. In this configuration, AC power from power grid 108 may flow directly to port 118 without passage through electromechanical system 103. Although not illustrated in FIG. 5, in this configuration, machine 106 may be disconnected from power grid 108 so that machine 106 does not rotate shaft 112. In another charging configuration, contactors 120a, 120b, 120c may be closed and contactors 122a, 122b, 122c may be open to enable charging of the energy storage system 110 using electrical energy from machine 104 as discussed above with respect to FIG. 4.

In some embodiments, hybrid charging may be implemented where electrical energy from the machine 104 and electrical energy directly from the grid 108 are both used to charge the energy storage system 110 during a common charge cycle of the energy storage system 110. In one example discussed below, electrical energy from the machine 104 may be utilized to initially charge the energy storage system 110, and thereafter electrical energy may be provided directly from the grid 108 via contactors 122a, 122b, 122c to charge the energy storage system 110.

In one embodiment, contactors 120 and contactors 122 may be tied together so that contactors 120 and contactors 122 cannot be simultaneously closed. For example, contactors 120 and contactors 122 may be interlocked. In some configurations, control circuitry 116 may selectively open and close contactors 120 and contactors 122. Contactors 120, 122 may be referred to as a switching system.

When contactors 122 are closed, power converter 102 may be configured to present a composite AC signal at port 118 in the same manner as was described above in relation to FIG. 4 and the generation of the excitation signal. The frequency of this composite AC signal may be different than the frequency of the AC power provided by power grid 108. As a result, AC power may flow into port 118 from power grid 108. Such AC power may be rectified by power converter 102 and presented at port 113 as DC power in the manner described above in relation the FIG. 4. The DC power may be used to charge energy storage system 110.

One advantage that system 200 has over system 100 is that system 200 may have a greater efficiency because machine 104 and machine 106 are not involved in charging energy storage system 110. In system 100, some power is lost due to machine 106 and machine 104 because machine 106 and machine 104 are not able to perfectly convert electrical power from power grid 108 into mechanical power used to rotate shaft 112 and then back into electrical power flowing from the stator of machine 104 into port 118. Instead, some losses are incurred. These losses affect the efficiency of the system 100. Accordingly, only a percentage of the AC power consumed by machine 106 in charging energy storage system 110 will be stored by energy storage system 110.

In contrast, system 200 does not involve machine 106 or machine 104 in charging energy storage system 110. As a result, system 200 is more efficient than system 100 and a greater percentage of the AC power consumed by system 200 in charging energy storage system 110 is stored in energy storage system 110.

When connecting power grid 108 to power converter 102 via contactors 122, characteristics of AC power supplied by power grid 108 might be different than characteristics of the composite AC signal presented by power converter 102 at port 118. Such characteristics may include frequency, phase, magnitude, and/or other characteristics impacting power quality. If one or more of the characteristics are significantly different, a number of issues may arise. One issue is that large currents may flow from power grid 108 into port 118 of power converter 102. Such currents may be large enough that they trip a safety mechanism of power converter 102, thereby disabling power converter 102. Another issue is that harmonics may be reflected by power converter 102 back into power grid 108 if the frequencies or phases of the two signals are significantly different.

To prevent these issues from arising, alignment circuitry 124a, 124b, and 124c may placed in-line between power grid 108 and port 118. Alignment circuitry 124 may mitigate differences in characteristics. In one embodiment, alignment circuitry 124 may comprise one or more inductors and one or more capacitors forming low pass filter designs to attenuate high-frequency signals (e.g., large current spikes and harmonic signals). Other embodiments of alignment circuitry 124 are also possible in which alignment circuitry 124 reduces and/or mitigates differences between characteristics of AC power supplied by power grid 108 and the composite AC signal presented at port 118 by power converter 102.

Although FIG. 5 illustrates both alignment circuitry 124 and alignment circuitry 126, in some embodiments, alignment circuitry 126 and contactors 128 might not be part of system 200. In this embodiment, alignment circuitry 124 may be connected in-line between power grid 108 and contactors 122.

On the other hand, system 200 may include alignment circuitry 126a, 126b, and 126c in addition to alignment circuitry 124, as illustrated in FIG. 5. In this embodiment, alignment circuitry 126 may be connected in-line between alignment circuitry 124 and power converter 102 when contactors 122 are closed and contactors 128 are open. In another configuration, alignment circuitry 126 may be bypassed when contactors 122 and contactors 128 are closed.

Alignment circuitry 126 may be used when first connecting power grid 108 to power converter 102 to mitigate differences between characteristics of the AC power supplied by power grid 108 and the composite AC signal presented at port 118. For example, contactors 128 may be open when contactors 122 transition from being open to being closed. As a result, power from power grid 108 will flow through alignment circuitry 126 and alignment circuitry 126 will mitigate differences between the power from power grid 108 and the configuration of power converter 102 to mitigate large current spikes or other instances of large currents flowing into power converter 102.

Once contactors 122 have been closed for a while and the risk of current spikes has passed because power converter 102 has been adjusted to the power of power grid 108, contactors 128 may be closed so that power from power grid 108 bypasses alignment circuitry 126. Closing contactors 128 may be advantageous since alignment circuitry 126 may have some impedance causing a power loss between power grid 108 and power converter 102 when contactors 128 are open. Once power converter 102 is aligned with the power from power grid 108, the power loss due to the impedance of alignment circuitry 126 may be avoided by closing contactors 128. In this embodiment, alignment circuitry 126 may comprise inductors. Alignment circuitry 126 may mitigate power quality issues that tend to arise at startup when power grid 108 is initially connected to power converter 102.

In this embodiment, alignment circuitry 124 may be configured to filter harmonics and perform other functions that minimize undesired effects resulting from differences in phase and frequency between the power of power grid 108 and power converter 102, but might not be configured to mitigate current spikes. In this embodiment, alignment circuitry 124 may comprise capacitors and may generally improve the power quality. Alignment circuitry 124 may remain in-line between power grid 108 and power converter 102 even when contactors 128 are closed because alignment circuitry 124 may mitigate power quality issues that tend to arise any time that power grid 108 is connected to power converter 102, and not just when power grid 108 is initially connected to power converter 102.

In one embodiment, a method of charging energy storage system 110 may include starting at a point when contactors 122 are open and contactors 128 are open. The method includes opening contactors 120 simultaneous with or prior to closing contactors 122. As a result of closing contactors 122, power will flow from power grid 108 through alignment circuitry 124 and alignment circuitry 126 to power converter 102. The method further includes leaving contactors 128 open for a period of time sufficient to allow power converter 102 to be aligned with power grid 108 and to allow for current spikes flowing from power grid 108 toward power converter 102 to be intercepted and mitigated (e.g., dissipated, absorbed, attenuated, etc.) by alignment circuitry 126. Once the period of time has passed, the method includes closing contactors 128. As a result, power from power grid 108 will flow through alignment circuitry 124, contactors 128, and contactors 122 to power converter 102, bypassing alignment circuitry 126.

After a period of time during which energy storage system 110 is charged by power converter 102 using power supplied by power grid 108 through contactors 122, contactors 122 may be opened. As a result, the charging of energy storage system 110 may cease. In one embodiment, control circuitry 116 may open and close contactors 120, 122, and 128 as described in the method above.

System 200 may also include conditioning circuitry 127 placed between power converter 102 and energy storage system 110. Conditioning circuitry 127 may be used to refine the DC voltage provided at port 113. For example, conditioning circuitry 127 may remove or reduce an AC component present at port 113 so that a conditioned DC voltage is presented via interface 129 to energy storage system 110. Conditioning circuitry 127 may be used with some battery technologies that work best with a DC voltage free from significant AC components. As was mentioned above, some battery technologies may actually work best with a DC voltage that does have an AC component.

Like system 100, system 200 may be used to charge energy storage system 110. Control circuitry 116 may alter one or more parameters of power converter 102 to charge energy storage system 110. For example, control circuitry 116 may open contactors 120 then close contactors 122 and configure a frequency set point of power converter 102 so that a DC voltage higher than a voltage of energy storage system 110 is presented at port 113. As a result, DC power will flow from port 113 into energy storage system 110 thereby charging energy storage system 110.

Control circuitry 116 may alter the frequency set point of power converter 102 over time to change the rate at which energy storage system 110 is charged as was described above. Furthermore, a parameter other than the frequency set point may be configured by control circuitry 116 to control the rate at which energy storage system 110 is charged. For example, as was described above, control circuitry 116 may change a DC voltage parameter associated with port 113 rather than the frequency set point.

Referring to FIG. 5A, a synchronization circuit 121 is shown according to one embodiment. Synchronization circuit 121 may be utilized to connect plural AC systems with one another, such as power grid 108 and interface 118 of power converter 118. As mentioned previously, electrical energy from electromechanical system 103 may be initially utilized to charge energy storage system 110, and control circuitry 116 may thereafter control energy system 200 to utilize electrical energy from power grid 108 to charge energy storage system 110. Synchronization circuit 121 may be used to connect power grid 108 with power converter 102 at an appropriate moment in time in one embodiment. Synchronization circuit 121 may be used with contactors 120a-c and one or more of alignment circuits 124a-c, 126a-c in some embodiments.

In one embodiment, control circuitry 116 may determine an appropriate moment in time to switch connection of interface 118 from electromechanical system 103 to power grid 108 (e.g., as a result of the voltage of the energy storage system 110 exceeding the peak voltage of the power grid 108 plus a hysteresis value as described below in one example). First, control circuitry 116 may open contactors 120a-c to electrically isolate electromechanical system 103 and interface 118. Thereafter, power converter 102 may be controlled to output a composite AC signal via port 118 having a specified or selected characteristic. In one example, the frequency of the composite AC signal may be selected corresponding to and slightly mismatched from the frequency of electrical energy upon the power grid 108. For example, in North America, the power converter 102 may output an AC waveform having a frequency of approximately 59.9 Hz corresponding to an expected frequency of 60 Hz of electrical energy upon the power grid 108.

Synchronization circuit 121 receives the composite AC signal outputted from the power converter 102 and also monitors a corresponding leg of power grid 108. In one embodiment, the synchronization circuit 121 is implemented as a synchronization check relay which operates to close contacts 123 once the phases of the composite AC signal from interface 118 and power grid 108 are in sufficient alignment and which couple the three phases of the power grid 108 with the three phase interface 118. The contactors 120a-c and contacts 123 may be referred to as a switching system. Other circuit configurations may be used to electrically couple the power grid 108 and power converter 102 in other embodiments.

In some embodiments, a respective inductor may be in series between each of the contacts 123 (or contactors 122a-c if utilized) and the interface 118 to reduce or minimize in-rush of current to power converter 102 upon closing of the contacts 123 (or contactors 122a-c).

Methods for charging energy storage system 110 will now be described. According to one embodiment, a battery charging method includes configuring a plurality of selectively conducting devices, such as the IGBTs described above, to collectively conduct a first current at a port (e.g., port 118). A magnitude of the first current varies in a periodic fashion so that the first current has a first frequency. The method further includes applying a second alternating current having a second frequency greater than the first frequency to the port. The second alternating current may be provided by the stator of machine 104 in one embodiment. In another embodiment, the second alternating current may be provided by power grid 108.

The method further includes extracting power from the second alternating current waveform via the plurality of selectively conducting devices. An amount of the extracted power is related to a difference between the second frequency and the first frequency. The method also includes using the extracted power to charge a battery or bank of batteries (e.g., energy storage system 110). The method may also include rectifying the extracted power prior to using the extracted power to charge the battery.

According to another embodiment, a battery charging method includes setting a frequency set point of a variable frequency drive (e.g., power converter 102) at a first frequency and applying an alternating current having a second frequency greater than the first frequency to a port (e.g., port 118) of the variable frequency drive. The method also includes extracting power from the alternating current via the variable frequency drive during the applying of the alternating current. An amount of the extracted power may be related to a difference between the second frequency and the first frequency. The method also includes using the extracted power to charge a battery. The alternating current may be supplied by a power grid. Alternatively, the alternating current may be supplied by an induction machine (e.g., machine 104) operating at a synchronous frequency with respect to a power grid.

According to another embodiment, a battery charging method includes extracting power from an alternating current applied to a variable frequency drive and using the extracted power to charge one or more batteries. The method also includes monitoring a voltage of the one or more batteries and altering a frequency set point of the variable frequency drive based on the monitoring, thereby altering an amount of the extracted power.

Altering the frequency set point may include communicating (e.g., via control circuitry 116) a desired frequency to the variable frequency drive. Alternatively, altering the frequency set point may include communicating a desired DC voltage (e.g., via control circuitry 116) to the variable frequency drive.

In one embodiment, the method may include increasing the frequency set point of the variable frequency drive as the voltage of the one or more batteries increases. Prior to extracting the power, the method may include adjusting a DC voltage of the variable frequency drive to be substantially the same as a voltage of the one or more batteries. After the adjusting of the DC voltage, the method may also include closing contactors thereby electrically connecting the variable frequency drive to a power grid, the power grid supplying the alternating current.

As discussed above, in some embodiments, energy storage system 110 may include one or more rechargeable batteries which may be arranged in a battery bank or pack. Different chemistries of batteries may be utilized which have different associated charging profiles and/or parameters which should be used or observed for proper or improved operation. For example, with lead acid batteries, there are well known charging current profiles and voltage limits which are used to avoid damaging the batteries. In some charging schemes, charging may initially be implemented using a constant current when the batteries are substantially discharged. This phase may be followed by a constant voltage “top off” second phase where the voltage applied to the batteries is held constant, but the current is allowed to decay. The second phase allows the batteries to absorb all possible charge without overheating or damaging the batteries. Furthermore, the charging may be halted when a minimum power consumption level is reached during charging. In this illustrative charging example, the thresholds or levels are typically configurable over a wide range of voltages and currents to support a variety of battery chemistries and system topologies. In some arrangements, the control circuitry 116 may store charging profiles or schemes which should be utilized based upon the batteries utilized within the energy storage system 110. The control circuitry 116 may monitor one or more characteristic of the energy storage system 110 (e.g., voltage of a battery bank) and adjust charging operations as a result of the monitoring (e.g., switch from constant current to constant voltage, control electrochemical system 103 or grid 108 to provide the charging energy, etc.).

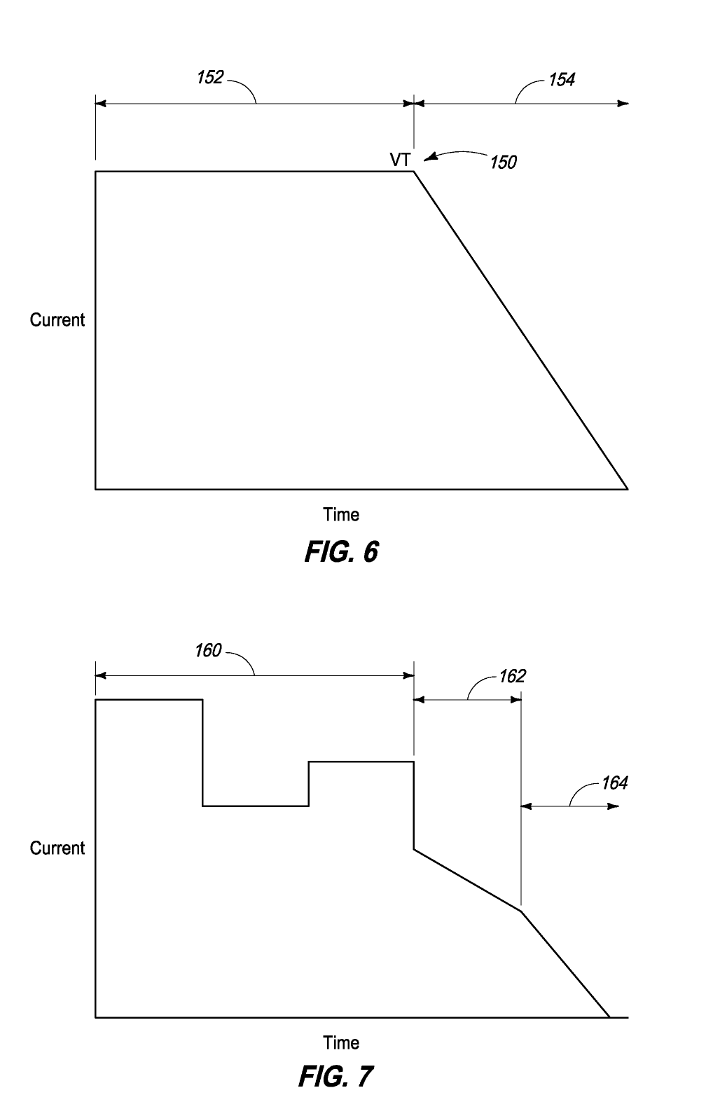

Referring to FIG. 6, an example method of charging batteries is described. For some batteries, a voltage target (VT) level 150 of the energy storage system 110 may be specified which indicates that the batteries of the bank 110 are nearing a fully charged state. In one charging scheme, the control circuitry 116 may control charging operations to switch phases of charging from use of constant current to a phase where the current is steadily reduced to maintain a constant target voltage. In this example, there are two distinct charging domains or phases including the first phase 152 using constant current where battery voltage is allowed to rise with time. The second phase or region 154 is entered when a target voltage level 150 is reached by the energy storage system 110. From this point in time onward, the voltage applied to the batteries is held at a constant voltage and the current is reduced to keep the voltage from rising.

System 100 and system 200 are both capable of operating in constant current and constant voltage battery charging modes as well as combinations of these modes along with other charging modes, such as variable voltage and current. For example, referring to FIG. 7, another example charging method includes three phases or regions including a first phase 160 where variable current is utilized for charging, a second phase 162 where variable current and voltage are used, and a third phase 164 where constant voltage is used. The systems 100, 200 are not limited to these example charging modes but rather the described charging modes are illustrative examples of modes which may be implemented by the systems 100, 200 to charge batteries of the energy storage system 110.

As mentioned above, system 200 may perform hybrid charging in some embodiments where charging is implemented using electrical energy from machine 104 as well as using electrical energy direct from the grid 108 without machine 106 and machine 104. In one hybrid charging example of energy storage system 110, electrical energy from electromechanical system 103 may be initially used to charge the energy storage system 110 and thereafter electrical energy from power grid 108 may be used to charge system 110 without use of electromechanical system 103. The following is one example method of using the electrical energy from machine 104 of electromechanical system 103 to charge the energy storage system 110.

Initially, the line frequency of the grid 108 may be measured using sensor circuitry 117 and processed by control circuitry 116. Thereafter, control circuitry 116 may control power converter 102 to use current from energy storage system 110 to ramp the speed of the machine 104 and shaft 112 coupled to machine 106 to approximately the same speed as the measured grid frequency (e.g., 59.99 Hz). Once the machine 104 and machine 106 reach synchronous speed with the grid frequency, the stator of the machine 106 is electrically coupled with the power grid 108 which aligns the phases of the machine 104 and machine 106 with the phase of the power grid 108 while neither producing or consuming significant power with respect to the power grid 108.

Thereafter, the control circuitry 116 instructs power converter 102 to slow down the perceived speed of the machine 104 by outputting the excitation signal having a frequency less than the frequency of the electrical energy upon the grid 108 in this example which causes the machine 104 to generate current for charging the energy storage system 110. By controlling the frequency of the excitation signal outputted by power converter 102 in this example, control circuitry 116 can control the current delivered into the power converter 102 and amount of energy used for charging the energy storage system 110. Control circuitry 116 may monitor and control the power converter 102 to provide charging of the energy storage system 110 according to the desired charging scheme as described above.

If the system 100 is being utilized (or system 200 is being utilized without the hybrid charging or direct grid charging described herein), the control circuitry 116 allows the current provided by the power converter 102 to the system 110 to drop to provide constant voltage charging once the voltage of the energy storage system 110 reaches the voltage level (VT) for the batteries of the energy storage system 110.

As also discussed herein, instead of using electrical energy from machine 104, system 200 may use electrical energy directly from power grid 108 without use of electromechanical system 103 in some embodiments. As discussed above, the control circuitry 116 may open contactors 120a, 120b, 120c to isolate the machine 104 and power converter 102 and the contactors 122a, 122b, 112c may be closed to provide electrical energy directly from the power grid 108 to the power converter 102 without use of the electromechanical system 103.

If hybrid charging is being utilized, electrical energy from machine 104 may initially be utilized for charging followed by use of electrical energy directly from power grid 108. Efficiency gains are provided by use of electrical energy directly from the grid as opposed to using machine 104 and machine 106. However, as discussed below, electrical energy from machine 104 may first be used to charge the energy storage system 110 to a desired voltage level to avoid uncontrolled current paths. Thereafter, following charging of the energy storage system 110 to a desired state of charge, electrical energy directly from the power grid 108 may be used to complete the charging of the energy storage system 110 for increased efficiency.

In one example, energy storage system 110 may include a plurality of series connected batteries to provide a desired operational voltage. In one more specific illustrative example, energy storage system 110 may include a series-connected stack of 26 lead acid batteries (12V nominal per battery) providing a DC bus voltage which ranges from approximately 267 VDC when discharged to approximately 367 VDC when fully charged. The range of 267-367 VDC represents a functional charging range for power converter 102 in this example.

Power grid 108 may provide three phase AC power at 208 VAC providing a peak or maximum AC voltage of approximately 294 Volts which is less than a voltage target (VT) of 367 VDC corresponding to the maximum voltage of the energy storage system 110 in this presently-described example. If the voltage of the energy storage system 110 is below 294 Volts, then an uncontrolled current flow may result during portions of the AC sine wave where the power grid AC peak voltage is above the voltage of the energy storage system 110. In a more specific example, free-wheeling diodes may be provided in parallel across switches (e.g., IGBTs) of power converter 102 and/or in parallel across input inductors to protect the components from inductive voltage transients which occur when current is switched on and off to port 118. However, these protection diodes create the potential for uncontrolled current paths when the voltage of the energy storage system 110 is below the AC peak voltage of power grid 108.

Accordingly, in one embodiment, electrical energy from the electromechanical system 103 is utilized to charge the energy storage system 110 when the voltage of the energy storage system 110 is below the AC peak voltage of the power grid 108. The voltage of the energy storage system 110 increases during this charging. Following the increase of the voltage of the energy storage system 110 above the AC peak voltage plus a hysteresis value, the system 200 may continue to use electrical energy from system 103 for charging, or be switched to continue the charging using electrical energy directly from the grid 108 for improved efficiency (i.e., compared with use of machine 104 and machine 106 with the inherent losses thereof).

In one example operational embodiment, the control circuitry 116 may monitor the voltage of the energy storage system 110 from power converter 102 and the voltage of power grid 108 from sensor circuitry 117. If the voltage of the energy storage system 110 is less than the peak AC voltage of the power grid 108 plus a hysteresis value, the control circuitry 116 implements charging of the energy storage system 110 using electrical energy from machine 104. If the voltage of the energy storage system 110 is greater than the peak AC voltage of the power grid 108 plus the hysteresis value, the control circuitry 116 may switch the switching system to implement charging of the energy storage system 110 using electrical energy from power grid 108 without the electromechanical system 103 for improved efficiency.

In compliance with the statute, embodiments of the invention have been described in language more or less specific as to structural and methodical features. It is to be understood, however, that the entire invention is not limited to the specific features and/or embodiments shown and/or described, since the disclosed embodiments comprise forms of putting the invention into effect.

Further, aspects herein have been presented for guidance in construction and/or operation of illustrative embodiments of the disclosure. Applicant(s) hereof consider these described illustrative embodiments to also include, disclose and describe further inventive aspects in addition to those explicitly disclosed. For example, the additional inventive aspects may include less, more and/or alternative features than those described in the illustrative embodiments. In more specific examples, Applicants consider the disclosure to include, disclose and describe methods which include less, more and/or alternative steps than those methods explicitly disclosed as well as apparatus which includes less, more and/or alternative structure than the explicitly disclosed structure.

What is claimed is:

1. An energy system comprising:
a first induction machine;
a second induction machine mechanically coupled with the first induction machine, wherein the second induction machine is configured to utilize first electrical energy to provide a first rotational force to rotate the first induction machine at a first moment in time and to output second electrical energy at a second moment in time as a result of receiving a second rotational force from the first induction machine; and
a power converter electrically coupled with the second induction machine and configured to provide the first electrical energy to the second induction machine which is utilized by the second induction machine to provide the first rotational force at the first moment in time, to receive the second electrical energy outputted from the second induction machine at the second moment in time, and to provide the second electrical energy to an energy storage system to charge the energy storage system.

2. The system of claim 1 wherein the power converter is configured to receive third electrical energy from a power grid and to provide the third electrical energy to the energy storage system to charge the energy storage system at a third moment in time.

3. The system of claim 2 wherein the energy storage system has a voltage greater than a peak voltage of the power grid when the energy storage system is in a substantially fully charged state, and wherein the power converter is configured to increase a voltage of the third electrical energy prior to the provision of second and third electrical energy to the energy storage system.

4. The system of claim 2 further comprising control circuitry configured to monitor an electrical characteristic of the energy storage system, and to control the charging using the second and third electrical energy as a result of the monitoring.

5. The system of claim 4 wherein the monitored electrical characteristic is voltage, and the control circuitry is configured to control the charging of the energy storage system using the second electrical energy as a result of the voltage of the energy storage system being below a peak voltage of electrical energy of the power grid and to control the charging of the energy storage system using the third electrical energy as a result of the voltage of the energy storage system being above the peak voltage of electrical energy of the power grid.

6. The system of claim 2 wherein the first induction machine is configured to consume fourth electrical energy from the power grid to provide the second rotational force at the second moment in time.

7. The system of claim 1 wherein the power converter is configured to apply an excitation signal to a stator of the second induction machine and to receive the second electrical energy from the stator of the second induction machine as a result of the application of the excitation signal.

8. The system of claim 7 wherein the power converter to adjust the excitation signal to adjust the amount of the second electrical energy which is outputted by the second induction machine.

9. The system of claim 8 further comprising control circuitry configured to monitor an electrical characteristic of the energy storage system, and to control the adjustment of the excitation signal using the monitoring.

10. The system of claim 9 wherein the control circuitry is configured to control the adjustment of the excitation signal using a charging profile of the energy storage system.

11. The system of claim 8 wherein the power converter is configured to adjust the frequency of the excitation signal to adjust the excitation signal.

12. The system of claim 7 wherein the first induction machine is configured to consume fourth electrical energy from a power grid to provide the second rotational force at the second moment in time, and wherein the power converter is configured to apply the excitation signal having a frequency less than a frequency of electrical energy of the power grid.

13. The system of claim 1 wherein the power converter is configured to pulse width modulate the first electrical energy and the second electrical energy.

14. The system of claim 1 further comprising the energy storage system comprising at least one rechargeable battery.

15. An energy system comprising:
a power converter;
an electromechanical system configured to rotate a shaft to generate first charging electrical energy;
a switching system coupled with the power grid, the electromechanical system, and the power converter, and wherein the switching system is configured to apply the first charging electrical energy to the power converter at a first moment in time and to apply second charging electrical energy from the power grid to the power converter at a second moment in time; and
wherein the power converter is configured to apply the first and second charging electrical energy to an energy storage system to charge the energy storage system.

16. The system of claim 15 wherein the power converter is configured to convert the first and second charging electrical energy received from the switching system from a first format to a second format, and further comprising control circuitry configured to monitor an electrical characteristic of the energy storage system and to control the conversion of the first and second charging electrical energy using the monitoring.

17. The system of claim 15 further comprising control circuitry configured to monitor an electrical characteristic of the energy storage system, and to control the switching system to apply the first charging electrical energy and the second charging electrical energy to the power converter using the monitoring.

18. The system of claim 17 wherein the monitored electrical characteristic is voltage, and the control circuitry is configured to control the switching system to apply the first charging electrical energy to the power converter as a result of the voltage of the energy storage system being below a peak voltage of electrical energy of the power grid and to control the power converter to apply the second charging electrical energy to the energy storage system as a result of the voltage of the energy storage system being above the peak voltage of electrical energy of the power grid.

19. The system of claim 15 wherein the electromechanical system is configured to use electrical energy from a power grid to rotate the shaft.

20. The system of claim 19 wherein the electromechanical system comprises a plurality of induction machines coupled with the shaft, and wherein a stator of one of the induction machines is coupled with the power grid and a stator of another of the induction machines is coupled with the switching system.

21. An energy storage system charging method comprising:
applying an excitation signal to a stator of an induction machine;
outputting electrical energy from the stator of the induction machine during the applying; and
charging an energy storage system using the electrical energy outputted from the stator.

22. The method of claim 21 further comprising:
rotating a shaft of the induction machine at a rotational velocity; and
selecting a characteristic of the excitation signal which corresponds to the rotational velocity to control an amount of the electrical energy outputted from the stator to be used for the charging.

23. The method of claim 21 further comprising:
monitoring the energy storage system; and
using the monitoring, adjusting a characteristic of the excitation signal to adjust an amount of the electrical energy which is outputted from the stator and used to charge the energy storage system.

24. The method of claim 21 further comprising:
discharging electrical energy from the energy storage system; and
applying the discharged electrical energy to the stator of the induction machine.

25. The method of claim 21 wherein the charging comprises first charging, and further comprising:
receiving electrical energy from a power grid after the first charging; and
second charging the energy storage system using the electrical energy from the power grid after the first charging.

26. The method of claim 25 further comprising:
monitoring a characteristic of the energy storage system; and
using the monitoring, switching from the first charging to the second charging.

27. The method of claim 21 wherein the induction machine comprises a first induction machine, and further comprising:
discharging electrical energy from the energy storage system to the stator of the first induction machine;
using the first induction machine, rotating a shaft during the discharging; and
applying electrical energy to a power grid from a stator of a second induction machine which receives a rotational force from the rotating shaft.

28. The method of claim 27 wherein the rotating comprises first rotating the shaft, and further comprising:
using the second induction machine, receiving electrical energy from the power grid; and
using the second induction machine and the electrical energy received from the power grid, second rotating the shaft; and
wherein the applying the excitation signal and the outputting the electrical energy comprise applying and outputting during the second rotating the shaft.
